(19) United States
(12) Patent Application Publication
(10) Pub. No.: US 2023/0126194 A1
(43) Pub. Date: Apr. 27, 2023

(54) DETECTOR DEVICE FOR DETECTING A LEAKAGE

(71) Applicant: emz-Hanauer GmbH & Co. KGaA, Nabburg (DE)

(72) Inventors: Josef IRLBACHER, Nabburg (DE); Martin BRABEC, Nabburg (DE); Christian MEIER, Guleneck (DE)

(73) Assignee: emz-Hanauer GmbH & Co. KGaA, Nabburg (DE)

(21) Appl. No.: 18/049,862

(22) Filed: Oct. 26, 2022

(30) Foreign Application Priority Data
Oct. 27, 2021 (DE) 102021127945.3
May 6, 2022 (DE) 102022111303.5

(51) Int. Cl. H04B 5/00

(52) U.S. Cl. CPC H04B 5/0025; H04B 5/0056

(57) ABSTRACT

The invention relates to a detector device for detecting a leakage, in particular for a household water-carrying system, the detector device comprising a sensor device having at least two subsets of sensors, the at least two subsets of sensors being provided on or in a housing of the detector device, the subsets of sensors being arranged in different geometric levels of the housing, the detector device detecting a change of an electrical parameter between at least two sensors.

### CROSS-REFERENCE TO RELATED APPLICATIONS

This application claims the benefit of Germany Patent Application No. 10 2021 127 945.3 filed Oct. 27, 2021, and German Patent Application No. 10 2022 111 303.5 filed May 6, 2022, the entire contents of which are incorporated herein by reference in their entireties.

### FIELD

The invention relates to a detector device for detecting a leakage, in particular for a water-carrying system in the household.

### BACKGROUND

Such systems can be, for example, washing machines, dishwashers, heating and hot water systems or systems for water treatment. Leakages or leaks in such systems or appliances can occur both in the supply and discharge devices in the form of hoses or also in certain components of the system or appliance. Leakages and leaks can indicate a malfunction or defect of the system or device. Furthermore, leakages or leaks can lead to damage to the building or other neighbouring equipment.

There are different levels of leaks. With minor leaks, only a small amount of moisture escapes. In the case of larger leaks, larger amounts of liquid escape, which can then cause undesirable damage to underlying or surrounding areas.

### SUMMARY

There is a need for a detector device to detect a leakage, especially for a water-carrying system in the household, which can be used flexibly and is inexpensive to manufacture. Furthermore, there is a need for a detector device which can detect different levels of leakage or leaks.

The problem is solved by the objects of the present disclosure. The subclaims comprise preferred embodiments.

According to the invention, there is provided a detector device for detecting a leakage, in particular for a household water-carrying system, the detector device comprising a sensor device having at least two subsets of sensors, the at least two subsets of sensors being provided on or in a housing of the detector device, the subsets of sensors being arranged in different geometric levels of the housing, the detector device detecting a change of an electrical parameter between at least two sensors.

Corresponding water-carrying systems can be, for example, washing machines, dishwashers, heating and hot water systems or systems for water treatment. By providing at least two subsets of sensors arranged in different geometric levels of the housing, the detector device can be adapted to the intended location, so that advantageously a detection of a change of an electrical parameter within a first subset of sensors indicates a small amount of leaked liquid. Detection of a change in an electrical parameter within a second subset of sensors or detection of a change in an electrical parameter between the first subset of sensors and a second subset of sensors would therefore indicate a greater amount of leaked fluid. Such a detector device can be manufactured simply and inexpensively and can be used extremely flexibly or adapted to the place of use.

Advantageously, the housing extends along a height axis Z, a width axis Y and a longitudinal axis X.

According to a preferred embodiment, the at least two geometric levels are spaced apart by a distance (h). Preferably, the distance (h) extends along the height axis Z of the housing. Cumulatively or alternatively, the at least two geometric levels are spaced apart by a distance along the longitudinal axis X of the housing and/or along the width axis Y of the housing. It is also conceivable that further subsets of sensors are provided, each of which is spaced apart by different distances. Thus, further levels or degrees of leakage can be detected. Cumulatively or alternatively, the housing could also be designed such that the different geometric levels represent a radial distance. Preferably, the housing has a curved and/or bended wall or surface on or in which the at least two subsets of sensors are provided. It would also be conceivable, for example, to have a step-shaped design of the housing, whereby the two geometric levels are designed. An advantageous design of the housing comprising a curved and/or bended wall or surface has the advantage that the detection device can be attached to a tube-like object or a hose. Furthermore, the curvature and/or curvature of the wall or surface can advantageously achieve the spacing of the two subsets of sensors by the distance h.

According to a further preferred embodiment, the sensor devices are suitable and intended to measure or detect an electrical parameter in the form of an electrical resistance or in the form of a capacitance between at least two sensors. It is also conceivable that the sensor devices are suitable and intended to detect a change in an electrical parameter in the form of an electrical resistance or in the form of a capacitance between at least two sensors. In an advantageous first state, at least two sensors are spatially spaced apart and isolated from each other by the ambient air. In the event that the measured electrical parameter is the electrical resistance, an approximately infinite resistance is thus measured between the two sensors in the first state. If both sensors are advantageously now in contact with a quantity of liquid, a wind level corresponding to the conductivity of the liquid is measured. Usually, water or a mixture containing water has a high electrical conductivity. In contrast to the first condition, a significant change in the measured resistance can thus be detected. Occurring moisture due to condensation will usually not lead to such a significant change of the electrical parameter. This avoids a possibly faulty triggering due to usually unproblematic condensation humidity. In an analogous manner, a change in capacitance between two sensors due to an amount of fluid between the two sensors can be described. The present invention is of course not limited to the measurement of the electrical parameter between two sensors. Measurements involving three or more sensors would of course also be conceivable.

According to a further preferred embodiment, the detector device comprises a control device which controls a measurement of the electrical parameter and evaluates the measurement result of the electrical parameter. Advantageously, the control device is signal-technically connected to the sensor device. A continuous measurement between two sensors or measurements within predetermined time intervals would be conceivable. It would also be conceivable that first a first measurement takes place using the first subset of sensors. For at least a small amount of liquid, such a first measurement would detect a change in the electrical parameter. Advantageously, the first measurement could be carried out continuously or at predetermined time distances. Furthermore, it would be conceivable that a second measurement is carried out as soon as a change in the electrical parameter has been detected in the first measurement using the first subset of sensors. The second measurement is advantageously carried out using sensors of the first subset and the second subset or using only sensors of the second subset. The second measurement can determine whether a significant amount of liquid has leaked. Advantageously, the control device controls the corresponding sequences of measurements. It is conceivable that an input device is provided by means of which a user can specify certain sequences of the measurements to the control device.

Advantageously, several subsets of sensors are provided, which are each arranged at different distances from one another on or in the housing. After a first measurement, further measurements can thus be carried out using sensors within these subsets or sensors of a subset and a subset arranged along the height axis above it. Thus, a gradual output of the leakage or the leaked quantity can be output.

According to a further preferred embodiment, the detector device comprises a communication device. Advantageously, the communication device is suitable and intended for establishing and/or operating a wireless communication link with a control device. However, it is also conceivable that the communication device is suitable and intended for establishing and/or operating a wireless communication link with another user device. The control device may be provided within the water-carrying system or may be an external control device. Such an internal control device may, for example, be provided in a household appliance. An external control device may, for example, be integrated in a surveillance system of a building. An otherwise user device could be a smartphone, tablet, personal computer or similar device. Preferably, the wireless communication link is a Bluetooth® link, a Bluetooth® low energy link, an RFID (radio-frequency identification) link, an NFC (near field communication) link, a WLAN link, a cellular link, a link using ISM bands, preferably free ISM bands, or a combination of the aforementioned links. ISM bands (Industrial, Scientific and Medical Band) are frequency ranges that can be used by high frequency devices in industry, science, medicine, in domestic and similar areas. Advantageously, the communication device comprises a transmitter device or a transmitter and receiver device. Advantageously, the communication device is signal-technically connected to the control device.

According to a further preferred embodiment, the first subset of sensors comprises at least two sensors. Preferably, the second subset of sensors comprises at least one sensor.

According to one embodiment, the detector device thus comprises a total of at least three or at least four sensors.

According to a further preferred embodiment, a self-sufficient power supply device is provided in the housing. By a self-sufficient power supply device is meant a power supply device which has no permanent connection to the mains. Such a self-sufficient power supply device could, for example, be a battery, a rechargeable battery (accumulator) or a similar current/voltage storage device. A power supply device based on photovoltaics or other power generation would also be conceivable. The rechargeable battery can advantageously be charged by means of a wireless charging method or a charging cable. Such an advantageous detector device can be used extremely flexibly due to its self-sufficient power supply and its communication device and can dispense with a fixed wired power supply. Preferably, the sensor device also does not require any wired communication transmission. The sensor device can be arranged on or near water-bearing parts, such as the hoses or pipes, the connections on the household appliance or the building, or even below the household appliance.

Advantageously, the housing can be sealed. The housing can thus be opened in order to be able to replace the power supply device and/or carry out maintenance work if necessary. After the replacement and/or maintenance work has been carried out, the housing can be sealed again so that no liquid can penetrate into the housing.

The detector device could advantageously have a monitoring device which monitors the state of charge of the power supply device, for example a battery or an accumulator. Thereby, in the event of a critically low state of charge, an output could be provided via the advantageous communication device and/or an output device provided therefor. Such an output device could be, for example, a display device or a tone generator.

According to a further preferred embodiment, the detector device comprises a fixing device by means of which the detector device can be fixed to a tube-like object or a hose. Such a fixing device could be a belt and/or a hose.

The present problem of the invention is also solved by a method for monitoring a leakage, in particular for a water-carrying system in the household, using a detector device according to one of the above-mentioned embodiments. In this context, the method can be equipped with all the features already described above in the context of the sensor device or the household appliance, either individually or in combination with one another, and vice versa.

Advantageously, a first measurement of the electrical parameter is performed using sensors of the first subset. Preferably, after a detection of a change of the electrical parameter in the first measurement, at least a second measurement is performed. Preferably, sensors of the first subset and sensors of the second subset or only sensors of the second subset are used in the second measurement.

In the case of at least a small amount of liquid, a change in the electrical parameter would be detected in such a first measurement. Advantageously, the first measurement could be performed continuously or at predetermined time distances. If at least a small amount of leaked liquid is now detected by means of the first measurement, a second measurement can be carried out. During the second measurement, a change in the electrical parameter is advantageously checked between at least one sensor of the first subset and at least one sensor of the second subset. The sensors of the second partial quantity are spaced apart from the first partial quantity by the distance h. Thus, a change in the electrical parameter during the second measurement would mean that the at least one sensor of the second subset is also in contact with the liquid. This is an indication that a considerable amount of leaked liquid is already present. The second measurement can also be made between at least one sensor of the second subset and at least one other sensor of the second subset. Here, too, a change in the electrical parameter indicates that a significant amount of leaked liquid is already present.

Alternatively, it would also be conceivable that measurements between sensors of the first subset and/or between sensors of the first subset and sensors of the second subset and/or between sensors of the second subset are carried out continuously or at predetermined time intervals.

The present task of the invention is also solved by a system comprising a water-carrying system in the household, for example a water-carrying household appliance, and at least one detector device according to one of the embodiments described above. The system can thereby be equipped with all the features already described above in the context of the sensor device or the household appliance, individually or in combination with one another, and vice versa.

Advantageously, the system may comprise several detector devices which are arranged on or in the vicinity of a water-carrying device or system. The detector devices are connected to the household appliance, a user device or other central control device by means of a wireless communication link. The respective detector device can transmit an identification code when a leaked liquid is detected, so that the location of the leaked liquid can be quickly localised. Furthermore, the respective detector device can communicate the level of the leaked liquid. This means that it is communicated whether a small amount or a substantial amount of leaked liquid is present.

Further advantages, objectives and features of the present invention will be explained with reference to the following descriptions of the accompanying figures. Similar components may have the same reference signs in the various embodiments.

### BRIEF DESCRIPTION OF THE DRAWINGS

The figures show:

FIG. 1 a perspective view of a detector device according to one embodiment;

FIG. 2 a schematic diagram of a circuit arrangement of the detector device;

FIG. 3 a side view of a detector device according to one embodiment;

FIG. 4 a top view from below of a detector device according to one embodiment;

FIG. 5 a top view from below of a detector device according to one embodiment;

FIG. 6 a view of a detector device according to one embodiment arranged on a tube-like object;

FIG. 7 a system comprising a household water-carrying system, and at least one detector device.

### DETAILED DESCRIPTION

FIGS. 1 to 6 show a detector device 1 for detecting a leakage, in particular for a water-carrying system in a household 100. The detector device 1 comprises a sensor device 2, which has at least two subsets 3, 4 of sensors 5, the at least two subsets 3, 4 of sensors 5 being provided on or in a housing 6 of the detector device 1, the subsets 3, 4 of sensors 5 being arranged in different geometric levels 7 of the housing 6, the detector device 1 detecting a change in an electrical parameter between at least two sensors 5.

The detector device extends along a longitudinal axis X, a width axis Y, and a height axis Z.

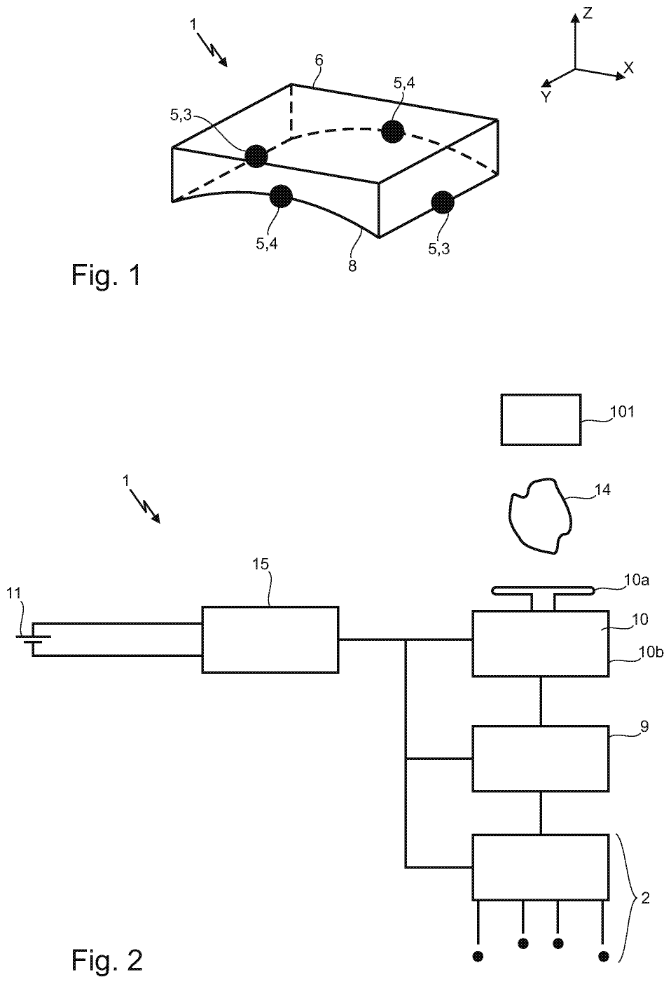

FIG. 2 shows some components of the detector device by means of a schematic diagram. The schematic diagram shows a self-sufficient power supply device 11 which supplies the individual components with voltage. In this embodiment, the power supply device is designed as a battery or a rechargeable battery (accumulator). Furthermore, a voltage conditioning device 15 is connected downstream of the battery or the rechargeable battery (accumulator), which adapts the battery voltage to the voltage required by the other components. The rechargeable battery (accumulator) can advantageously be charged by means of a wireless charging method or a charging cable. Accordingly, the housing could also comprise a corresponding connection device for a charging cable.

Further, the detector device 1 comprises a communication device 10 suitable and intended for establishing and/or operating a wireless communication link 14 with a control device 101 of the system 100. The wireless communication link 14 may be a Bluetooth® link, a Bluetooth® low energy link, an RFID (radio-frequency identification) link, an NFC (near field communication) link, a WLAN link, a cellular link, a link using ISM bands preferably free ISM bands or a combination of said links. In the present case, wireless communication link 14 is a Bluetooth® link. The communication device 10 thus comprises an antenna 10a and a Bluetooth® driver.

The communication device 10 is signal-connected to a control device 9. The control device controls a measurement of the electrical parameter by the sensor device 2 and evaluates the measurement result of the electrical parameter. The control device 9 is thus connected to the sensor device 2 in terms of signals.

The components are arranged in the housing 6 of the detector device 1. Advantageously, the housing can be opened and sealed. This makes it possible, for example, to replace the power supply device 11 if its state of charge is too low. For this purpose, a corresponding monitoring device can be provided which monitors the charge. In the event of a critical state of charge, an output device can be activated or a corresponding signal can be output via the communication device 10. The sealing closure ensures that no liquid enters the housing and damages the components.

The sensor device 2 is suitable and intended to measure an electrical parameter, in the form of an electrical resistance or in the form of a capacitance between at least two sensors 5. The control device can be designed in the form of a logic which triggers the respective measurement and then evaluates the measurement. Such an evaluation comprises an assessment of whether a change in the respective electrical parameter is sufficiently large. A sufficiently large change is present if the change is greater than the tolerance fluctuations caused by noise or other disturbances. For this purpose, the control device can be given a corresponding lower value which the change in the electrical parameter should exceed. If a change is detected, a further measurement can be initiated and/or a signal transmitted to the communication device 10, which then sends a corresponding warning signal.

The sensors can be in the form of electrodes which are connected to the sensor device 2 by means of signals. Electrodes which are provided for resistive measurement can be touched from the outside. Electrodes which are provided for capacitive measurement are covered and cannot be touched from the outside. The sensors 5 can be arranged on or in the housing 6. The sensors 6 could, for example, be arranged on the housing 6 by means of pads.

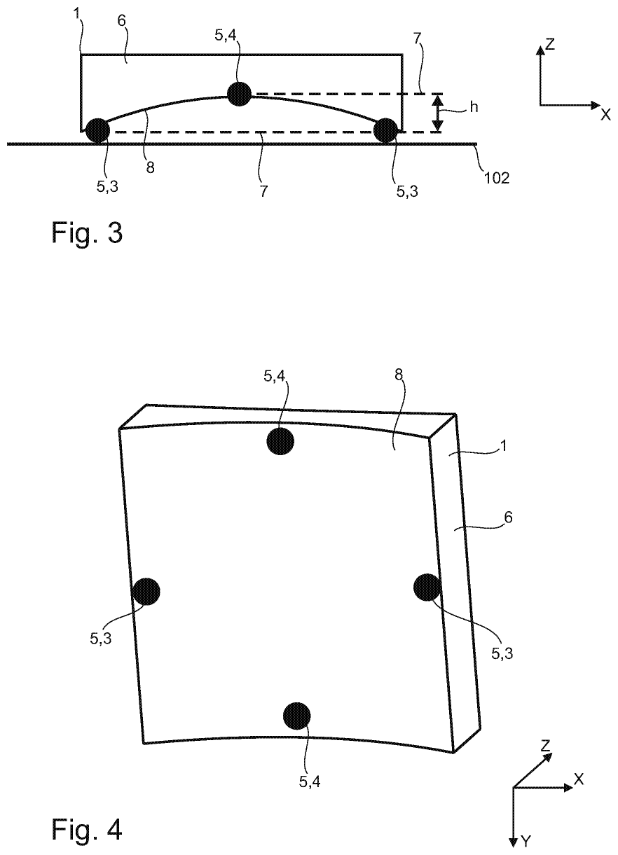

The subsets 3, 4 of sensors 5 are arranged at different geometric levels of the housing. According to the embodiments shown in the figures, the geometric levels are spaced apart by a distance h. In FIGS. 1 and 3 to 6 it is readily apparent that the sensors are arranged on or in a lower wall 8 or surface of the housing 6. This wall 11 is curved. The wall corresponds essentially to a section of a circular cylinder jacket. The sensors 5 of the second subset 4 are arranged substantially centrally on or in the curvature of the wall 10. The sensors 5 of the first subset 3 are arranged substantially at the outer edge of the curvature of the wall 10. It is clearly visible in FIG. 3 that the sensors 5 of the second subset 4 are thus spaced apart from the sensors 5 of the first subset 3 by the distance h. Due to the provision of the curvature, the detector device 1 can be used to be operated lying on a flat surface as well as to be arranged on a tube-like object or hose. Such a detector device is thus extremely versatile.

The first subset 3 of sensors 5 comprises at least two sensors 5. The second subset 4 of sensors 5 comprises at least one sensor 5. FIG. 4 shows an embodiment in which the first subset 3 and the second subset 4 of sensors 5 each comprise two sensors. The total of four sensors are arranged in a cross shape on or in the lower wall 11 of the housing. The sensors of the first subset of sensors 3 are thus arranged opposite each other along the longitudinal axis X. The sensors of the second subset of sensors 4 are arranged opposite each other along the width axis Y.

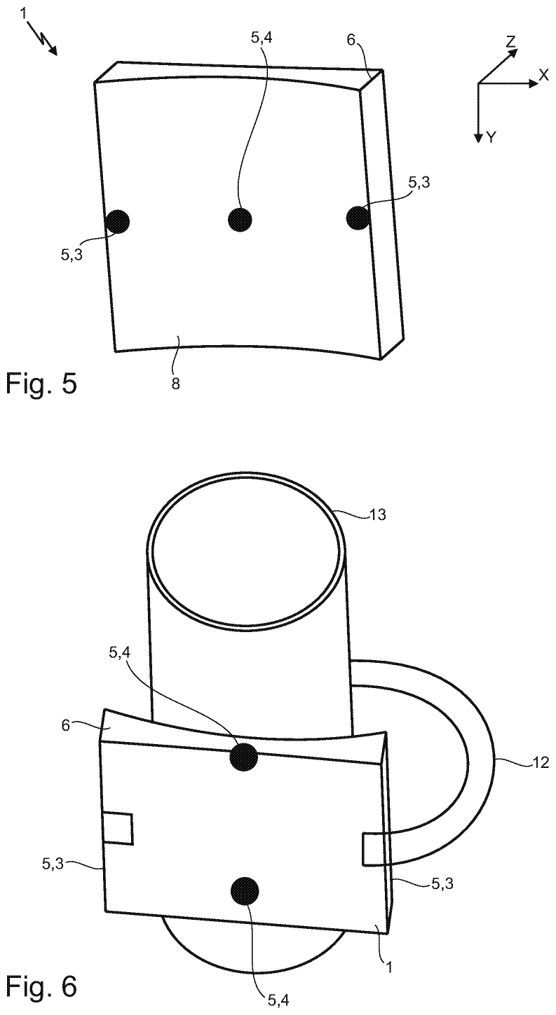

FIG. 5 shows an embodiment in which the first subset 3 comprises two sensors 5 and the second subset 4 comprises one sensor 5. The sensors of the first subset 3 are thus arranged opposite each other along the longitudinal axis X. The one sensor 5 of the second subset 4 is arranged along the longitudinal axis X between the two sensors 5 of the first subset 3. 3 sensors can be sufficient to detect the two different levels of leakage. By providing 4 sensors, additional information can be measured.

FIG. 3 shows an application where the detection device is placed on a flat area 102, for example the floor of a building. It can be seen that the sensors 5 face the area 14 and are placed at least 2 different distances from the area 14. The measurement detects a change in the electrical parameter caused by a fluid between at least two sensors 5. The sensors 5 of the first subset 3 are thus closer to the area 102 than the sensors 5 of the second subset 4, hence the latter respond first. A liquid between the sensors of the first subset 3 changes the electrical parameter in the form of a resistance or capacitance. As the liquid increases, the sensors 5 of the second subset of sensors 4 also respond. A measurement between the sensors 5 of the second subset 4 or between a sensor 5 of the first subset 3 and a sensor 5 of the second subset 4 therefore shows a corresponding change in the electrical parameter.

Of course, further geometric levels 7 and further subsets of sensors 5 can also be provided in order to enable a finer gradation of the leakage levels. Advantageously, a certain predetermined combination of detecting sensors 5 at different geometric levels can thus be assigned to certain leakage levels. Accordingly, both a leakage of a small amount of liquid and larger leaks can be detected. Depending on the level of leakage, different warning messages can be transmitted to a user of the household appliance.

FIG. 6 shows a detector device 1 which is arranged on a tube-like object, for example a hose. A fixing device 12 is provided for this purpose, which can be designed as a belt, for example. If a small amount of liquid escapes from the hose, a change in the electrical parameter would be detected by means of the sensors 5 of the second subset 4, as these are arranged centrally. Only when a larger amount of liquid escapes would a change in the electrical parameter also be detected by means of the sensors 5 of the first subset 3.

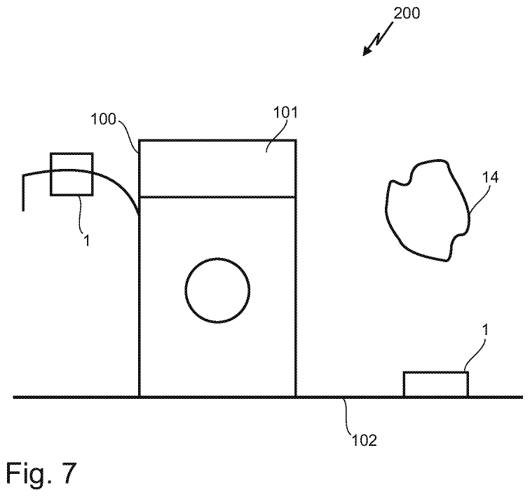

FIG. 7 shows a total system 200. The total system comprises the water-carrying system 100 in the household. Here, a water-carrying household appliance is shown, for example, as a washing machine or a dishwasher. However, the detector device is also applicable to other water-carrying systems in the household, for example heating and hot water systems or systems for water treatment.

Due to the self-sufficient power supply device and the wireless communication via the wireless communication link 14, the detector device 1 can be used extremely flexibly. It is also conceivable to use several detector devices 1 together. In FIG. 7, for example, one detector device 1 is arranged on an inlet or outlet of the household appliance and another detector device 1 is lying on the area 14 on which the household appliance is arranged.

The present invention thus provides a simple and robust detector device for the detection of leakages or leaks, which is capable of detecting multiple levels of leakage.

The applicant reserves the right to claim all features disclosed in the application documents as essential to the invention, provided that they are individually or in combination new compared to the prior art. It is further pointed out that the individual figures also describe features which may be advantageous in themselves. The person skilled in the art immediately recognises that a certain feature described in a figure can also be advantageous without adopting further features from this figure. Furthermore, the person skilled in the art recognises that advantages can also result from a combination of several features shown in individual figures or in different figures.

### LIST OF REFERENCES

1 Detector device
2 sensor device
3 first subset of sensors
4 second subset of sensors
5 sensors
6 housing
7 geometric levels
8 curved and/or bended wall or surface
9 control device
10 communication device
10a Antenna
10b Bluetooth® driver
11 Power supply device
12 Fixing device
13 tube-like object
14 wireless communication link
15 voltage conditioning device
100 household water-carrying system
101 control device of the system
102 Area
200 total system
h distance
X longitudinal axis of the detector device
Y Width axis of the detector device
Z Height axis of the detector device

What is claimed is:

1. A detector device for detecting a leakage, in particular for a water-carrying system in a household, wherein
the detector device comprises a sensor device having at least two subsets of sensors, the at least two subsets of sensors being provided on or in a housing of the detector device, the subsets of sensors being arranged in different geometric levels of the housing, the detector device detecting a change in an electrical parameter between at least two sensors.

2. The detector device according to claim 1, wherein
the at least two geometric levels are spaced apart by a distance, the housing having a curved and/or bent wall on or in which the at least two subsets of sensors are provided.

3. The detector device according to claim 1, wherein
the sensor device is suitable and intended to measure an electrical parameter, in the form of an electrical resistance or in the form of a capacitance between at least two sensors.

4. The detector device according to claim 1, wherein
the detector device comprises a control device which controls a measurement of the electrical parameter and evaluates the measurement result of the electrical parameter, the control device being connected to the sensor device in terms of signals.

5. The detector device according to claim 1, wherein
the detector device comprises a communication device, wherein the communication device is suitable and intended for establishing and/or operating a wireless communication link with a control device or other user device, wherein the wireless communication link comprises a Bluetooth® connection, a Bluetooth® Low Energy connection, a RFID (radio-frequency identification) connection, a NFC (near field communication) connection, a WLAN connection, a mobile radio connection, a connection using free ISM bands or a combination of said connections, wherein the communication device is signal-connected to the control device.

6. The detector device according to claim 1, wherein
the first subset of sensors comprises at least two sensors, wherein the second subset of sensors comprises at least one sensor.

7. The detector device according to claim 1, wherein
a self-sufficient power supply device is provided in the housing, wherein the housing is sealingly closable.

8. The detector device according to claim 7, wherein
the detector device comprises a fixing device by means of which the detector device can be fixed to a tube-like object.

9. A method for monitoring a leakage, in particular for a water-carrying system in a household, using a detector device according to claim 1.

10. A system comprising a water-carrying system in the household, and at least one detector device according to claim 1.
